(19) United States
(12) Patent Application Publication
(10) Pub. No.: US 2026/0189809 A1
(43) Pub. Date: Jul. 2, 2026

(54) DEPTH-OF-FIELD EXTENDER AND EXTENSION METHOD

(71) Applicant: OmniVision Technologies, Inc., Santa Clara, CA (US)

(72) Inventors: Paul Wickboldt, Santa Clara, CA (US); Jau-Jan Deng, Taipei (TW); Shih-Hsin Hsu, Taipei (TW); Chen-Hung Liao, Taipei (TW); Kuang-Ju Wang, Taipei (TW)

(21) Appl. No.: 19/002,248

(22) Filed: Dec. 26, 2024

(51) Int. Cl. H04N 23/958; G02B 27/00; H04N 23/55

(52) U.S. Cl. CPC H04N 23/958; G02B 27/0075; H04N 23/55

(57) ABSTRACT

A depth-of-field extender for an imaging system includes an optical element having a radially dependent thickness deviation proportional to an oscillatory function having a first envelope and a second envelope. The first envelope has a magnitude, at each of a plurality of radial distances, substantially equal to a difference between (i) a reference optical path length of a reference ray originating at the radial distance in an object plane located between a minimum and maximum object distance and (ii) an optical path length of a first ray originating at the radial distance in an object plane located at the minimum object distance. The second envelope has a magnitude, at each radial distance, substantially equal to a difference between (i) the reference optical path length and (ii) an optical path length of a second ray originating at the radial distance in an object plane located at the maximum object distance.

### BACKGROUND

An imaging system can form acceptably sharp images of objects located within only a limited range of object distances in object space of the image system. This range of object distances is called the depth of field (DOF). Existing methods of extending the depth of field suffer drawbacks such as low signal-to-noise ratio, increased space requirements, and limited DOF extension.

### SUMMARY OF THE EMBODIMENTS

Embodiments disclosed herein remedy one or more of the above-mentioned deficiencies.

In a first aspect, a method for extending depth of field of an imaging system between a minimum object distance and a maximum object distance is disclosed. The method includes adding phase delay to the imaging system. The phase delay may be added to an aperture stop of the imaging system. The phase delay is an oscillatory function of radial distance from the optical axis of the imaging system. A first envelope of the oscillatory function has a first magnitude, at each of a plurality of radial distances, substantially proportional to a first difference between (i) a reference optical path length of a reference ray originating at the radial distance in a reference object plane located between the minimum and maximum object distance and (ii) a first optical path length of a first ray originating at the radial distance in a first object plane located at the minimum object distance. A second envelope of the oscillatory function has a second magnitude, at each of the plurality of radial distances, substantially proportional to a second difference between (i) the reference optical path length and (ii) a second optical path length of a second ray originating at the radial distance in a second object plane located at the maximum object distance. The first envelope is one of an upper envelope and a lower envelope of the oscillatory function. The second envelope is other of the upper envelope and the lower envelope. The method also includes convolving an image, captured with the imaging system, with a filter kernel equal to the inverse Fourier transform of a quotient. The quotient is a target transfer function divided by the optical transfer function of the imaging system with the added phase delay.

In a second aspect, a depth-of-field extender for an imaging system is disclosed. The depth-of-field extender includes an optical element having a radially dependent thickness deviation proportional to an oscillatory function having the first envelope and the second envelope described in the method of the first aspect.

### BRIEF DESCRIPTION OF THE FIGURES

FIG. 1 is a schematic of an imaging system that may include a DOF extender, in an embodiment.

FIG. 2 is a plot of optical path differences as a function of normalized ray height in an embodiment of imaging system of claim 1 that does not include a DOF extender.

FIG. 3 is a schematic cross-sectional view of an imaging system, which is an example of imaging system of FIG. 1.

FIG. 4 and FIG. 5 are respective plots of the point-spread function (PSF) and modulation transfer function (MTF) of imaging system of FIG. 3.

FIG. 6 is plot of optical path differences as a function of normalized ray height for the imaging system of FIG. 3.

FIG. 7 is a plot of a phase delay of a DOF extender, which is an example of the DOF extender of FIG. 1.

FIG. 8 is a plot of phase delays of the DOF extender of FIG. 7.

FIG. 9 is a surface-sag plot of the DOF extender of FIG. 7.

FIG. 10 is a schematic cross-sectional view of an extended DOF imaging system, which is an example of the image system of FIG. 1.

FIG. 11 and FIG. 12 are respective plots of the point-spread function (PSF) and modulation transfer function (MTF) of images captured by the imaging system of FIG. 10.

FIG. 13 is an MTF plot of an EDOF image obtained by applying a convolution filter to one of captured images of FIG. 11.

FIG. 14 is a flowchart illustrating a method for extending depth of field of an imaging system.

### DETAILED DESCRIPTION OF THE EMBODIMENTS

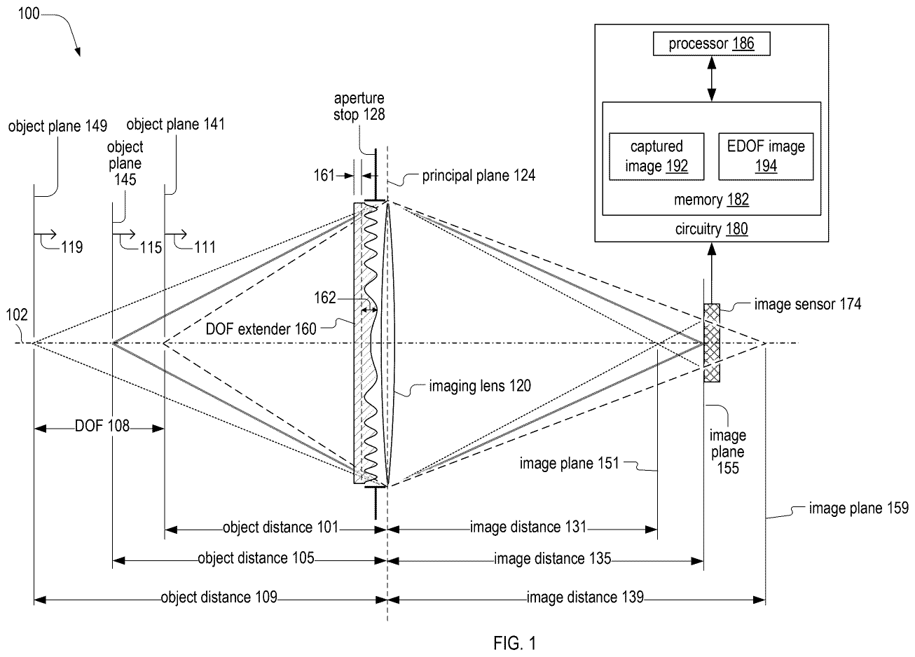

FIG. 1 is a schematic of an imaging system 100 that includes an imaging lens 120 and an image sensor 174. Imaging system 100 has an optical axis 102 and an aperture stop 128. FIG. 1 depicts an object plane 141, a reference object plane 145, and an object plane 149, and respective corresponding image planes 151, 155, and 159. That is, image planes 151, 155, and 159 are conjugate planes of object planes 141, 145, and 149, respectively. Image plane 155 is located at a light-sensing surface of image sensor 174, such that image plane 155 is the focal plane of imaging system 100 and images of objects in object plane 145 optimally focused compared to objects located at other object distances.

Imaging lens 120 has a principal plane 124. Object planes 141, 145, and 149 are located at respective object distances 101, 105, and 109 from principal plane 124 on the object-space side of imaging lens 120. Image planes 151, 155, and 159 are located at respective image distances 131, 135, and 139 from principal plane 124 on the image-space side of imaging lens 120. Imaging system 100 has a depth of field 108, which may be a difference between object distance 109 and object distance 101. Herein, object distances, image distances, and depth of field 108 are along a direction parallel to optical axis 102.

Imaging system 100 includes a depth-of-field extender 160, hereinafter DOF extender 160. DOF extender 160 is located between object plane 141 and image plane 151 along optical axis 102. For example, DOF extender 160 may be located at aperture stop 128. DOF extender 160 may be optically transparent at least one of ultraviolet wavelengths, visible wavelengths, and near-infrared wavelengths.

In imaging system 100, DOF extender 160 may be located at any plane in the optical path where the OPD may be determined as a well behaved function of the radius. This plane may or may not correspond to aperture stop 128 For example DOF extender 160 may be at or on a surface of an optical element of imaging system 100, such as imaging lens 120.

Image sensor 174 captures an image formed by imaging system 100. Imaging system 100 may include circuitry 180, which is communicatively coupled to image sensor 174. Circuitry 180 may include a memory 182 and a processor 186 that is communicatively coupled to memory 182. Memory 182 stores the captured image as captured image 192. Circuitry 180 may be part of image sensor 174.

Memory 182 may be transitory and/or non-transitory and may include one or both of volatile memory (e.g., SRAM, DRAM, computational RAM, other volatile memory, or any combination thereof) and non-volatile memory (e.g., FLASH, ROM, magnetic media, optical media, other non-volatile memory, or any combination thereof). Part or all of memory 182 may be integrated into processor 186.

Memory 182 stores software that includes non-transitory machine-readable instructions. When executed by processor 186, the software causes processor 186 to implement the imaging processing functionality of circuitry 180 as described herein. The software may be, or include, firmware.

Processor 186 represents any type of circuit or integrated circuit capable of performing logic, control, and input/output operations. For example, processor 186 may include one or more of a microprocessor with one or more central processing unit (CPU) cores, a graphics processing unit (GPU), a digital signal processor (DSP), a field-programmable gate array (FPGA), a system-on-chip (SoC), a microcontroller unit (MCU), and an application-specific integrated circuit (ASIC). Processor 186 may also include a memory controller, bus controller, and other components that manage data flow between processor 186 and memory 182.

Circuitry 180 convolves the image with a filter kernel to yield an EDOF image 194, which may also be stored in memory 182. The filter kernel equals, or is proportional to, the inverse Fourier transform of a quotient. The numerator of the quotient may be a target optical transfer function, such as the optical transfer function of imaging system 100 without depth-of-field extender 160. The target optical transfer function may be an optical transfer function corresponding to a targeted system performance. The denominator of the quotient is the optical transfer function of imaging system 100 with depth-of-field extender 160. In embodiments, memory 182 stores machine-readable instructions that, when executed by the processor 186, cause processor 186 to convolve the image with the filter kernel.

Expressed mathematically, the filter kernel of the convolution filter is g(x, y) as defined in equation (1), where [symbol] ⁻¹ is an inverse Fourier transform and f denotes spatial frequency.

$$g ( x , y ) = {ℱ}^{- 1} ( G ( f ) ) \qquad ( 1 )$$

In embodiments, filter function G(f) equals H(f)_{target}/H(f)_{capt}, where H(f)_{capt} is the optical transfer function of imaging system 100 that captures the image and includes DOF extender 160. H(f)_{target} is an optical transfer function an imaging system that is identical to imaging system 100, except that it lacks DOF extender 160. H(f)_{target} may be the OTF of the non-EDOF imaging system for an object distance equal to the in-focus object plane, or may be another optical transfer function for a targeted system performance.

Filter function G(f) may be expressed by equation (2)

$$G ( f ) = \frac{{H ( f )}_{target}}{{H ( f )}_{capt}} [ \frac{1}{1 + 1 / ( {\vert {H ( f )}_{capt} \vert}^{2} S N R )} ] \qquad ( 2 )$$

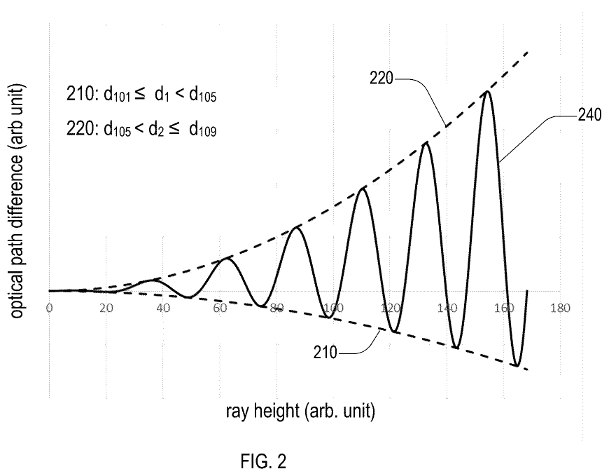

FIG. 2 is a plot of optical path differences 210 and 220 as a function of normalized ray height for rays originating a respective object distances d₁ and d₂ in an embodiment of imaging system 100 that does not include DOF extender 160. Each optical path distance ends at image plane 155. Object distance d₁ is greater than or equal to object distance 101 and less than object distance 105. Object distance d₂ is greater than equal to object distances 105 and less than or equal object distance 109.

Ray height is in a direction perpendicular to optical axis 102. The normalized ray height is normalized to a radius of aperture stop 128. At a given ray height, optical path differences 210 and 220 are deviations from optical path length of rays originating from object plane 145.

The plot of FIG. 2 also includes an oscillatory optical path difference 240 imposed by DOF extender 160, herein also OPD(r). The relationship between optical path difference OPD and phase delay Δφ that DOF extender 160 imparts on light transmitted therethrough is given by equation (3).

$$Δ ϕ ( r ) = ( ω / c ) OPD ( r ) = ( ω / c ) ( n \cdot d ( r ) ) \qquad ( 3 )$$

In equation (3), ω is the angular frequency of the light, c is the speed of light in vacuum, n is the refractive index of DOF extender 160 at angular frequency ω, and d(r) is the thickness of DOF extender 160 as a function of distance r from optical axis 102.

In embodiments, DOF extender 160 may be a gradient-index optical element with a radially-dependent refractive index n(r). In such embodiment, the geometric thickness of DOF extender 160 may be constant, in which case DOF extender 160 may be plano-plano optical element. Accordingly, herein the “thickness” of DOF extender 160 may be an “optical thickness”: OPD(r)=n(r)·d(r). Herein, OPD(r) is also referred to as a radially-dependent thickness deviation 162.

DOF extender 160 has a radially dependent thickness deviation 162 (OPD(r)), which is equal or proportional to an oscillatory function having a first envelope and a second envelope. When DOF extender 160 has a spatially uniform refractive index, DOF extender 160 may also include a spatially-uniform base thickness 161, such that the total thickness is the sum of thickness 161 and thickness deviation 162. The radially-dependent geometric thickness is d(r) introduced in eq. (3), above.

The optical path difference imposed by DOF extender 160 is OPD(r)=n·d(r), per eqn. (1), or more generally n(r)·d(r). Examples of the thickness deviation, the first envelope, and the second envelope, are optical path difference 240, optical path difference 210, and optical path difference 220. The above-mentioned oscillatory function

The first envelope has a first magnitude, at each of a plurality of radial distances, substantially equal to a first difference between (i) a reference optical path length of a reference ray 115 originating at the radial distance in reference object plane 145 located between object distance 101 and object distance 109 and (ii) a first optical path length of a first ray 111 originating at the radial distance in object plane 141 located at object distance 101. To reduce diffraction effects, a minimum period of the oscillatory function may exceed a wavelength of light represented by reference ray 115.

The second envelope has a second magnitude, at each of the plurality of radial distances, substantially equal to a second difference between (i) the reference optical path length and (ii) a second optical path length of a second ray 119 originating at the radial distance in object plane 149 located at object distance 109. Each of the first magnitude and the second magnitude may zero at a radial distance r=0, as illustrated by optical path differences 210 and 220 of FIG. 2.

The first envelope is one of an upper envelope and a lower envelope of the oscillatory function and the second envelope is other of the upper envelope and the lower envelope. In the example of FIG. 2, optical path difference 210 is the first envelope and optical path difference 220 is the second envelope. In embodiments, the first envelope is the upper envelope and the first difference is (i) the reference optical path length subtracted from the first optical path length and (ii) being non-negative for each of the plurality of radial distances. In other embodiments, the second envelope is the upper envelope and the second difference is (i) the reference optical path length subtracted from the second optical path length and (ii) non-negative for each of the plurality of radial distances.

In embodiments, the base thickness is uniform, and hence independent of radial distance r. Alternatively, the base thickness may be radially symmetric as a function of radial distance from optical axis 102. In such embodiments, depth-of-field extender 160, in absence of the thickness deviation, either adds power to, or subtracts power from, the optical system. That is, the thickness deviation may be added to lens of imaging system 100.

Optical path difference OPD(r) may be an oscillatory function that has a frequency that increases a function of radial distance r, which has resulted in superior depth of field extension in certain designs. That is, OPD(r) may have a positive chirp. For example OPD(r) may be proportional to Aₑₙᵥ(r) cos(k(r)·r^{β}), where Aₑₙᵥ(r) is defined by optical path differences 210 and 220. The positive chirp may result from one or more of k(r) being an increasing function and exponent β being positive.

The oscillatory function may be expressed by equation (4).

$$Δ ϕ ( r ) = \frac{{E}_{2} ( r ) - {E}_{1} ( r )}{{D}_{1}} cos ( 2 π {{v}_{r} ( r / {r}_{m ax} )}^{β} ) + \frac{{E}_{2} ( r ) + {E}_{1} ( r )}{{D}_{2}} \qquad ( 4 )$$

In eqn. (4), r is the radial distance, E₁(r) is the first envelope, E₂(r) is the second envelope, vᵣ is a spatial frequency, and D₁, D₂, and β, are a real numbers. Radius rₘₐₓ may be less than or equal to r, and may the radius of the aperture stop 128, e.g., when DOF extender 160 is located at object distance 109. Radius rₘₐₓ may be a radius of DOF extender 160, a radius of the clear aperture of DOF extender 160. In embodiments, D₂=2.

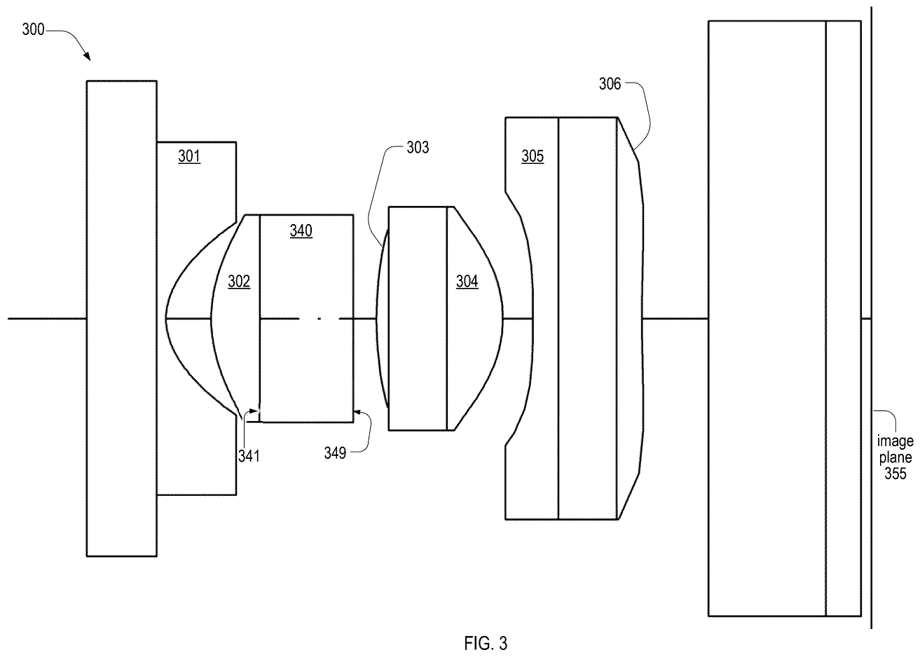

FIG. 3 is a schematic cross-sectional view of an imaging system 300, which is an example of imaging system 100. Imaging system 300 includes lenses 301, 302, 303, 304, 305, and 306. Imaging system 300 also includes an optical element 340 that has planar object-side surface 341 and an image-side surface 349. Image-side surface 349 is planar, in which case imaging system 300 does not include a DOF extender 160. The aperture stop of imaging system 300 is at surface 349. Imaging system 300 forms an image at an image plane 355, which is an example of image plane 155.

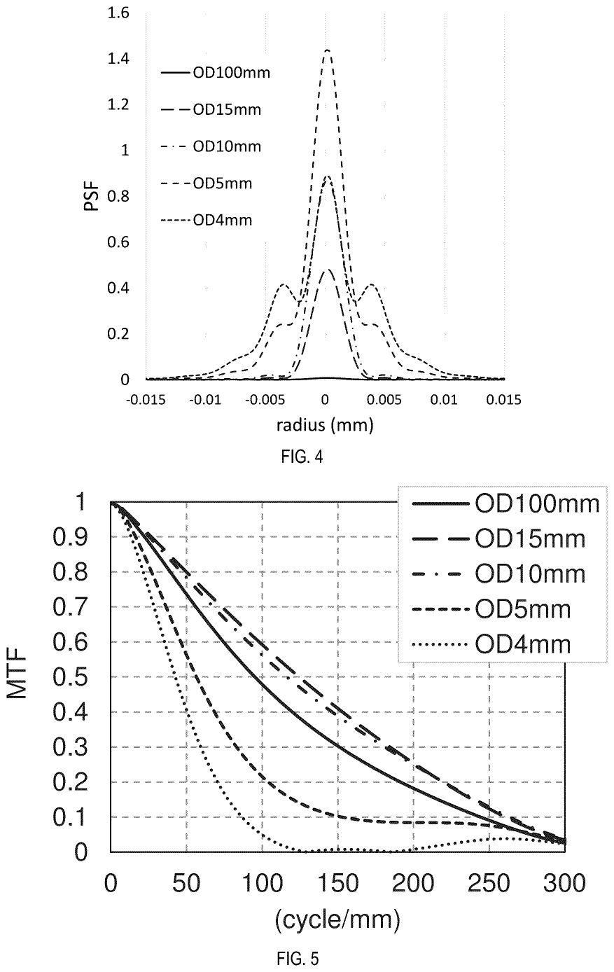

FIG. 4 and FIG. 5 are respective plots of the point-spread function (PSF) and modulation transfer function (MTF) of imaging system 300 for object distances ranging from 4 mm to 100 mm, where a 15-mm object distance is the in-focus object plane. Both the PSF and MTF vary considerably for the difference object distances. For example, at 100 line-pairs per mm, the MTF at the 15-mm object distance is approximately three times that of the MTF at the 5-mm object distance.

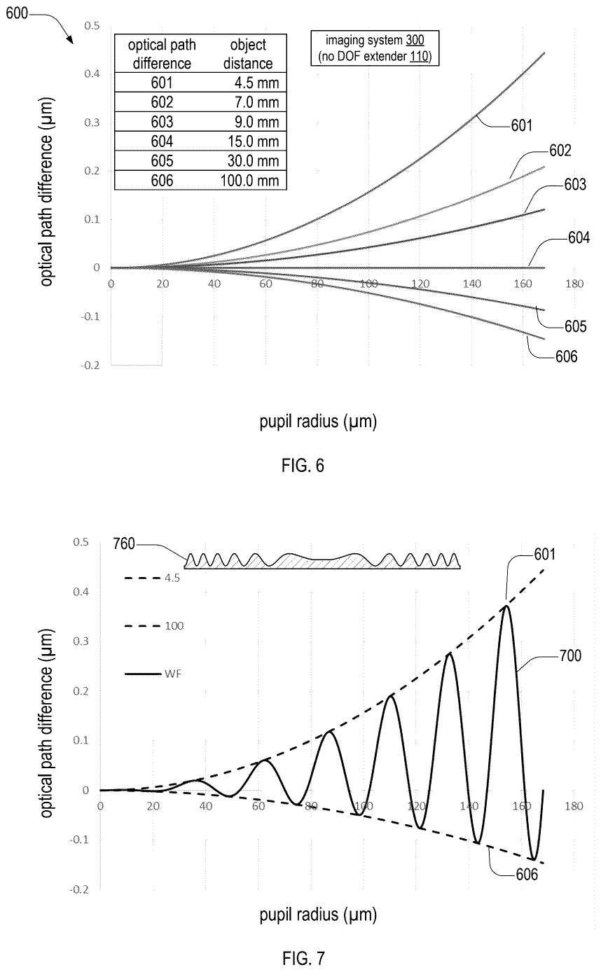

FIG. 6 is plot 600 of optical path differences 601-606 as a function of normalized ray height for imaging system 300. In plot 600, each optical path difference is given by (Rₛ−Zₛ), where Rₛ is the radius of the spherical wavefront imparted by imaging system 300 and Zₛ is the distance between image plane 355 and the principal plane of imaging system 300. As mentioned previously, the best-focus object plane corresponds to an object distance of 15 millimeters, which is an example of object distance d₂ of FIG. 2. Optical path differences 601, 602, and 603 correspond to object distances 4.5 mm, 7.0 mm, and 9.0 mm, each of which is an example of object distance d₁ of FIG. 2. Optical path difference 604 corresponds to the 15.0-mm object distance. Optical path differences 605 and 606 correspond to respective object distances 30.0 mm and 100.0 mm, each of which is an example of object distance d₃ of FIG. 2. Optical path differences 601 and 606 are examples, of optical path difference 220 and 210, respectively.

FIG. 7 is a plot of an optical path differences 700 of a DOF extender 760, which is an example of DOF extender 160. Optical path differences 700 is an oscillatory function of radial distance from optical axis 102.

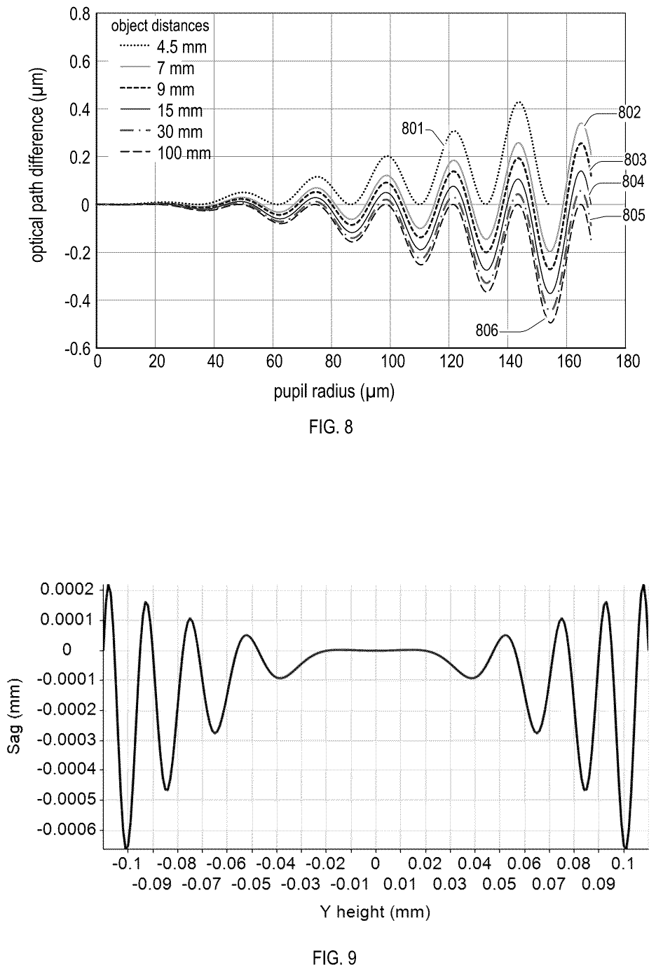

FIG. 8 is a plot of optical path differences 801, 802, 803, 804, 805, and 806 of DOF extender 760 as a function of normalized ray height. optical path differences 801-806 are equal to phase optical path difference 700 subtracted from respective optical path differences 601-606. For example, optical path difference 801 is optical path difference 700 subtracted from optical path difference 601.

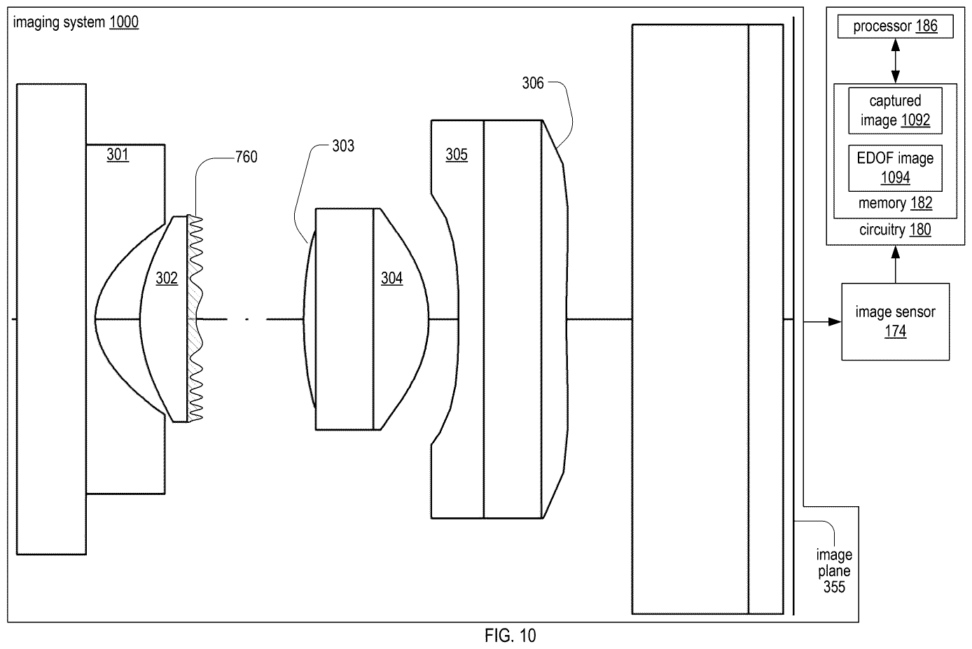

FIG. 9 is a surface-sag plot of DOF extender 760. FIG. 10 is a schematic cross-sectional view of an extended DOF imaging system 1000, hereinafter EDOF imaging system 1000. EDOF imaging system 1000 is the same imaging system 300, but with DOF extender 760 replacing optical element 340. Herein, a “non-EDOF imaging system” corresponding to an EDOF imaging system is the EDOF imaging system with the DOF extender 160 replaced by a plano-plano optical element having a same nominal thickness as DOF extender 160.

FIG. 10 depicts image sensor 174, which has a light-sensing surface that may be located at image plane 355. Image sensor 174 may be communicatively coupled to circuitry 180. One or both of image sensor 174 and circuitry 180 may be part of imaging system 1000. Images captured by imaging system 1000 may be stored as captured images 1092, which are examples of captured image 192. Memory 182 may store EDOF image 1094, which is an example of EDOF image 194.

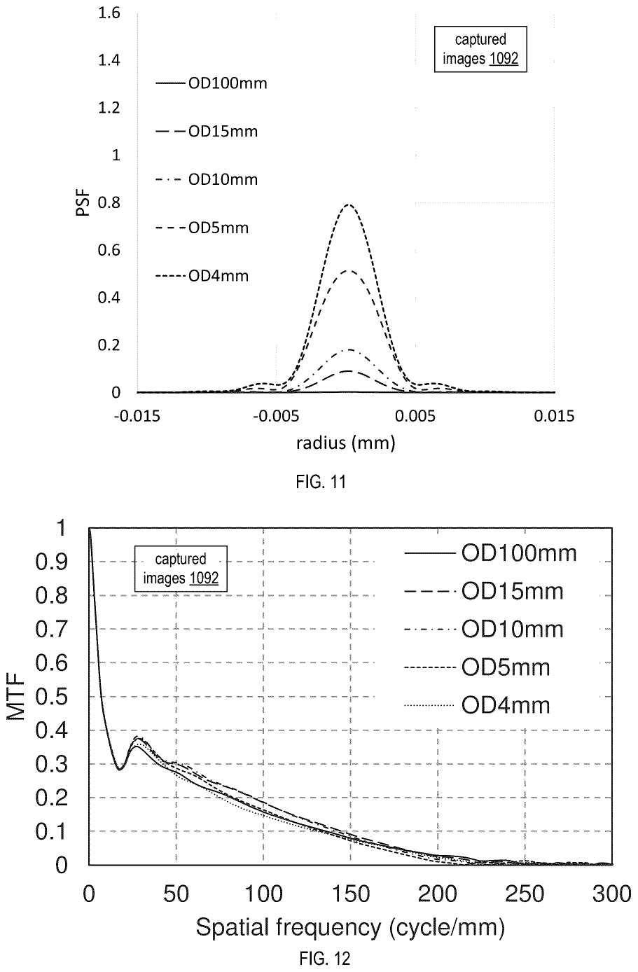

FIG. 11 and FIG. 12 are respective plots of the point-spread function (PSF) and modulation transfer function (MTF) of captured images 1092 captured by EDOF imaging system 1000. Each captured image 1092 is an example of a captured image 192, FIG. 1, and corresponds to a respective one of the object distances shown in FIGS. 11 and 12. Compared to the PSFs and MTFs of imaging system 300 (FIGS. 4 and 5), the PSFs and MTFs are substantially identical for object distances between 4 mm and 100 mm.

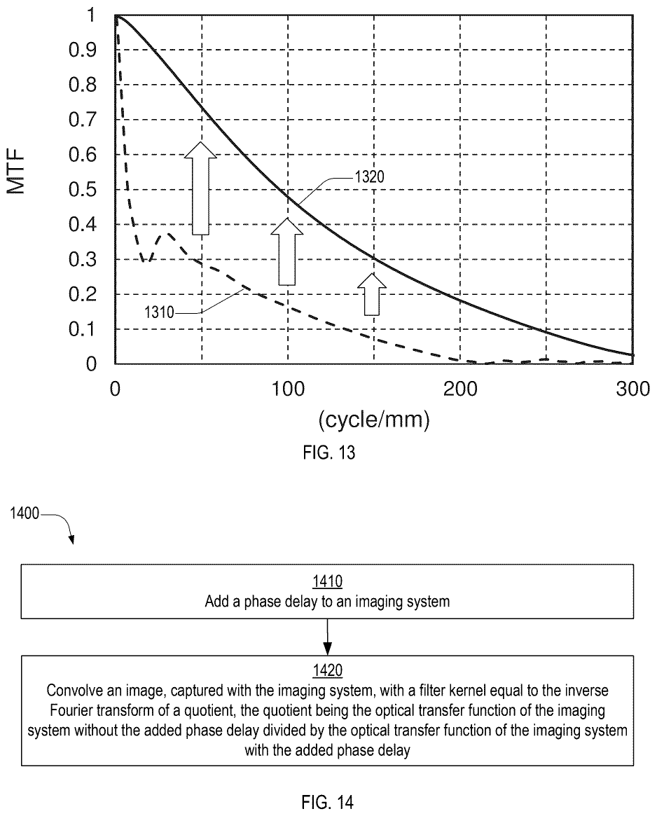

FIG. 13 is an MTF plot of an example EDOF image 1094 output by EDOF imaging system 1000 after applying a convolution filter to one of captured images 1092. EDOF image 1094 is an example of EDOF image 194, FIG. 1. FIG. 13 includes MTF 1310 and MTF 1320. MTF 1310 is an average of MTFs of FIG. 12. MTF 1320 is the MTF of imaging system 300 when imaging objects at its in-focus object distance, which is 15 millimeters in this example. In this example, H(f)_{target} is an optical transfer function of imaging system 300 and H(f)_{capt} is the optical transfer function of imaging system 1000.

FIG. 14 is a flowchart illustrating a method 1400 for extending depth of field of an imaging system between a minimum object distance and a maximum object distance. In embodiments, method 1400 is implemented within one or more aspects of imaging system 100. For example, method 1400 may be implemented by processor 186 executing computer-readable instructions stored in memory 182. Method 1400 includes at least one of steps 1410 and 1420.

Step 1410 includes adding phase delay to the imaging system. The phase delay may be added to (or at) an aperture stop of the imaging system. The phase delay is an oscillatory function of radial distance from the optical axis of the imaging system. Phase delay Δφ(r) of eqn. (3) is an example of the phase delay.

A first envelope of the oscillatory function has a first magnitude, at each of a plurality of radial distances, substantially proportional to a first difference between (i) a reference optical path length of a reference ray originating at the radial distance in a reference object plane located between the minimum and maximum object distance and (ii) a first optical path length of a first ray originating at the radial distance in a first object plane located at the minimum object distance. A second envelope of the oscillatory function has a second magnitude, at each of the plurality of radial distances, substantially proportional to a second difference between (i) the reference optical path length and (ii) a second optical path length of a second ray originating at the radial distance in a second object plane located at the maximum object distance. The first envelope is one of an upper envelope and a lower envelope of the oscillatory function. The second envelope is other of the upper envelope and the lower envelope.

Step 1420 includes convolving an image, captured with the imaging system, with a filter kernel equal to the inverse Fourier transform of a quotient. The numerator of the quotient may be a target optical transfer function, such as the optical transfer function of the imaging system without the added phase delay. The target optical transfer function may be an optical transfer function corresponding to a targeted system performance. The denominator of the quotient may be the optical transfer function of the imaging system with the added phase delay. Filter kernel g(x, y) of eqn. (1) is an example of the filter kernel of step 1420.

Features described above, as well as those claimed below, may be combined in various ways without departing from the scope hereof. The following enumerated examples illustrate some possible, non-limiting combinations.

Changes may be made in the above methods and systems without departing from the scope of the present embodiments. It should thus be noted that the matter contained in the above description or shown in the accompanying drawings should be interpreted as illustrative and not in a limiting sense. Herein, and unless otherwise indicated the phrase “in embodiments” is equivalent to the phrase “in certain embodiments,” and does not refer to all embodiments. As used in this specification, any appendices thereto, and the appended claims, the singular forms “a,” “an,” and “the” include plural referents unless the content clearly dictates otherwise.

The term “or” is generally employed in its sense including “and/or” unless the content clearly dictates otherwise. Regarding instances of the terms “and/or” and “at least one of,” for example, in the cases of “A and/or B,” “at least one of A and B,” and “at least one of A or B,” such phrasing encompasses the selection of (i) A only, or (ii) B only, or (iii) both A and B. In the cases of “A, B, and/or C,” “at least one of A, B, and C,” and “at least one of A, B, or C,” such phrasing encompasses the selection of (i) A only, or (ii) B only, or (iii) C only, or (iv) A and B only, or (v) A and C only, or (vi) Band C only, or (vii) each of A and B and C. This may be extended for as many items as are listed.

The following claims are intended to cover all generic and specific features described herein, as well as all statements of the scope of the present method and system, which, as a matter of language, might be said to fall therebetween.

We claim:

1. A method for extending depth of field of an imaging system between a minimum object distance and a maximum object distance, the method comprising:
adding phase delay to the imaging system, the phase delay being an oscillatory function of radial distance from the optical axis of the imaging system;
a first envelope of the oscillatory function having a first magnitude, at each of a plurality of radial distances, substantially proportional to a first difference between (i) a reference optical path length of a reference ray originating at the radial distance in a reference object plane located between the minimum and the maximum object distance and (ii) a first optical path length of a first ray originating at the radial distance in a first object plane located at the minimum object distance; and
a second envelope of the oscillatory function having a second magnitude, at each of the plurality of radial distances, substantially proportional to a second difference between (i) the reference optical path length and (ii) a second optical path length of a second ray originating at the radial distance in a second object plane located at the maximum object distance;
wherein (i) the first envelope is one of an upper envelope and a lower envelope of the oscillatory function and (ii) the second envelope is other of the upper envelope and the lower envelope.

2. The method of claim 1, further comprising:
convolving an image, captured with the imaging system, with a filter kernel equal to the inverse Fourier transform of a quotient, the quotient being a target optical transfer function divided by the optical transfer function of the imaging system with the added phase delay.

3. The method of claim 2, the target optical transfer function being the optical transfer function of the imaging system without the added phase delay.

4. The method of claim 1, adding a phase delay comprising adding the phase delay to an aperture stop of the imaging system.

5. The method of claim 1, the reference object plane and an image plane of the imaging system being conjugate planes.

6. The method of claim 1,
the first difference being (i) the reference optical path length subtracted from the first optical path length and (ii) non-negative for each of the plurality of radial distances; and
the first envelope being the upper envelope.

7. The method of claim 1,
the second difference being (i) the reference optical path length subtracted from the second optical path length and (ii) non-negative for each of the plurality of radial distances; and
the second envelope being the upper envelope.

8. The method of claim 1, the oscillatory function having a period that exceeds a wavelength of light represented by the reference ray.

9. The method of claim 1, each of the first magnitude and the second magnitude equaling zero at a radial distance of zero.

10. The method of claim 1, the oscillatory function being expressed by
$$Δϕ ( r ) = \frac{{E}_{2} ( r ) - {E}_{1} ( r )}{{D}_{1}} cos ( 2 π {{v}_{r} ( r / {r}_{ma x} )}^{β} ) + \frac{{E}_{2} ( r ) + {E}_{1} ( r )}{{D}_{2}} ,$$
where r is the radial distance, rₘₐₓ is less than or equal to r, E₁(r) is the first envelope, E₂(r) is the second envelope, vᵣ is a spatial frequency, and D₁, D₂, and β, are a real numbers.

11. A depth-of-field extender for an imaging system, comprising:
an optical element having a radially dependent thickness deviation proportional to an oscillatory function having a first envelope and a second envelope;
the first envelope having a first magnitude, at each of a plurality of radial distances, substantially equal to a first difference between (i) a reference optical path length of a reference ray originating at the radial distance in a reference object plane located between a minimum and a maximum object distance and (ii) a first optical path length of a first ray originating at the radial distance in a first object plane located at the minimum object distance;
the second envelope having a second magnitude, at each of the plurality of radial distances, substantially equal to a second difference between (i) the reference optical path length and (ii) a second optical path length of a second ray originating at the radial distance in a second object plane located at the maximum object distance;
wherein(i) the first envelope is one of an upper envelope and a lower envelope of the oscillatory function and (ii) the second envelope is other of the upper envelope and the lower envelope.

12. The depth-of-field extender of claim 11, the optical element having a total thickness that is the sum of (i) the radially dependent thickness deviation and (ii) a base thickness that is uniform as a function of radial distance from an optical axis of the imaging system.

13. The depth-of-field extender of claim 12, as a function of radial distance from an optical axis of the imaging system, the base thickness being radially symmetric such that the depth-of-field extender such that, in absence of the thickness deviation, either adds power to, or subtracts power from, the optical system.

14. The depth-of-field extender of claim 11, the oscillatory function having a period that exceeds a wavelength of light represented by the reference ray.

15. The depth-of-field extender of claim 11, the oscillatory function having a frequency that increases as a function of radial distance.

16. The depth-of-field extender of claim 11, the oscillatory function being expressed by
$$Δ ϕ ( r ) = \frac{{E}_{2} ( r ) - {E}_{1} ( r )}{{D}_{1}} cos ( 2 π {{v}_{r} ( r / {r}_{ma x} )}^{β} ) + \frac{{E}_{2} ( r ) + {E}_{1} ( r )}{{D}_{2}} ,$$
where r is the radial distance, rₘₐₓ is less than or equal to r, E₁(r) is the first envelope, E₂(r) is the second envelope, v is a spatial frequency, and D₁, D₂, and β, are a real numbers.

17. An imaging system comprising:
the depth-of-field extender of claim 11 located along an optical axis of the imaging system;
an image sensor, located at an image plane of the imaging system, that captures an image formed by the imaging system; and
circuitry, communicatively coupled to the image sensor, that convolves the image with a filter kernel equal to the inverse Fourier transform of a quotient, the quotient being target optical transfer function divided by the optical transfer function of the imaging system with the depth-of-field extender.

18. The imaging system of claim 17, the target optical transfer function being the optical transfer function of the imaging system without the depth-of-field extender.

19. The imaging system of claim 17, the circuitry comprising:
a processor; and
a memory storing machine-readable instructions that, when executed by the processor, cause the processor to convolve the image with the filter kernel.

20. The imaging system of claim 17, the depth-of-field extender being located at an aperture stop of the imaging system.
